(19) United States
(12) Patent Application Publication
(10) Pub. No.: US 2023/0085946 A1
(43) Pub. Date: Mar. 23, 2023

(54) MANAGING USER INTERACTIONS FOR A GRAPHICAL USER INTERFACE

(71) Applicant: Intercom, Inc., San Francisco, CA (US)

(72) Inventors: Eoin Nolan, Dublin (IE); Alex Potrivaev, Dublin (IE)

(21) Appl. No.: 17/941,666

(22) Filed: Sep. 9, 2022

Related U.S. Application Data
(60) Provisional application No. 63/243,020, filed on Sep. 10, 2021.

(51) Int. Cl. G06F 9/451; G06F 9/54

(52) U.S. Cl. CPC G06F 9/451; G06F 9/54

(57) ABSTRACT

A system and method for managing user interactions for a graphical user interface. The method includes executing an application to cause the application to present a canvas and a plurality of nodes together on a display. The method includes configuring a plurality of hooks to control communication associated with bespoke logic. The method includes detecting a request to perform a first type of action associated with at least the canvas or a node of the plurality of nodes. The method includes acquiring information from the bespoke logic via a first hook that is associated with the first type of action. The method includes determining whether to grant or deny the request to perform the first type of action based on the information. The method includes granting the request to perform the first type of action, or denying the request to perform the first type of action.

### CROSS-REFERENCE TO RELATED APPLICATIONS

This application claims the benefit of U.S. Provisional Application Ser. No. 63/243,020 entitled “MANAGING USER INTERACTIONS FOR A GRAPHICAL USER INTERFACE,” filed Sep. 10, 2021, the disclosure of which is incorporated herein by reference in its entirety.

### TECHNICAL FIELD

The present disclosure relates generally to software technology, and more particularly, to systems and methods for managing user interactions for a graphical user interface.

### BACKGROUND

A graphical user interface (GUI) design principles conform to the model—view—controller software pattern, which separates internal representations of information from the manner in which information is presented to the user, resulting in a platform where users are shown which functions are possible rather than requiring the input of command codes. Users interact with information by manipulating visual widgets, which are designed to respond in accordance with the type of data they hold and support the actions necessary to complete the user's task.

### SUMMARY

One aspect disclosed herein is directed to a method for managing user interactions for a graphical user interface. The method includes executing an application to cause the application to present a canvas and a plurality of nodes together on a display. The method includes configuring a plurality of hooks to control communication associated with bespoke logic. The method includes detecting a request to perform a first type of action associated with at least the canvas or a node of the plurality of nodes. The method includes acquiring information from the bespoke logic via a first hook that is associated with the first type of action. The method includes determining whether to grant or deny the request to perform the first type of action based on the information. The method includes granting the request to perform the first type of action, or denying the request to perform the first type of action.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for managing communications with users and potential users of a communication system, according to some embodiments;

FIG. 2 is a graphical user interface of an example application depicting a method for building user paths, according to some embodiments;

FIG. 2A is a block diagram of an example application including shortcuts for content engagement predicates, according to some embodiments;

FIG. 2B is a block diagram of an example application including shortcuts for content engagement predicates, according to some embodiments;

FIG. 2C is a block diagram of an example application including shortcuts for content engagement predicates, according to some embodiments;

FIG. 2D is a block diagram of an example application including shortcuts for content engagement predicates, according to some embodiments;

FIG. 2E is a block diagram of an example application including shortcuts for content engagement predicates, according to some embodiments;

FIG. 3 is a block diagram of an example graphical editor, according to some embodiments;

FIG. 4 is a block diagram of an example graphical editor, according to some embodiments;

FIG. 5A is a block diagram depicting an example of the communication system 102 in FIG. 1, according to some embodiments;

FIG. 5B is a block diagram depicting an example of the customer device 116 in FIG. 1, according to some embodiments;

FIG. 6 is a flow diagram depicting a method for managing user interactions associated with inserting a node into a graphical user interface, according to some embodiments;

FIG. 7 is a flow diagram depicting a method for managing user interactions associated with inserting a node into a graphical user interface, according to some embodiments;

FIG. 8 is a flow diagram depicting a method for managing user interactions associated with deleting a node in a graphical user interface, according to some embodiments;

FIG. 9 is a flow diagram depicting a method for managing user interactions associated with connecting node in a graphical user interface, according to some embodiments;

FIG. 10 is a screen capture of an example list of hooks, according to some embodiments; and

FIG. 11 is a block diagram of an example computing device that may perform one or more of the operations described herein, in accordance with some embodiments.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements.

As used herein, the term “communication system” may refer to the system and/or program that manages communications between individuals and companies. The term “customer” may refer to a company or organization utilizing the communication system to manage relationships with its end users or potential end users(leads). The term “user” may refer to an end user or lead that is interfacing with the customer through the communication system. The term “company” may refer to an organization or business that includes a group of users. The term “engineer” or “developer” may refer to staff managing or programming the communication system.

As described in the below passages, the communication system may place (e.g., assign, allocate) users into user paths developed by the customers and monitors interaction of the users with the customers. The communication system may monitor and/or detect the interaction of the user with the customers. The communication system, in responsive to detecting the interaction of the user with the customer, interact with the users to advance the users along the user paths based on conditions set by the customer. The interactions with the users may include, but not be limited to, chats, instant messages, text messages, and emails. The communication system may include reporting functions that allow a customer to monitor the status of users along the developed user paths.

The conventional graphical user interfaces (sometimes referred to as, “graphical user interface libraries”) have several disadvantages. To start, the conventional GUIs are incompatible with custom-made user interface (UI) frameworks, thereby requiring the engineer developing the UI framework to ensure that the data in their data models are identically mapped to whatever the library is rendering. This would also require for the engineer to learn yet another framework and/or coding language, which may further delay the development of the UI framework. Furthermore, the existing tooling to test the UI frame work would also not be compatible with the conventional graphical user interface, which would degrade the engineer's ability to thoroughly test the UI framework. As a result, end-users and/or customers may eventually use unstable releases of the UI framework that are plagued with functionality and network security flaws, which allow bad actors to gain access to private networks to conduct malicious activities that often waste networking resources.

Aspects of the present disclosure address the above-noted and other deficiencies by managing user interactions for a graphical user interface. As discussed in greater detail below, the present disclosure provides a graphical user interface (GUI) of a graphical editor that includes a canvas for a customer to build and view a series. The graphical editor (sometimes referred to as, “graphical editor library” or “user interaction manager” or “graphical object manager”) was designed to be able to abstract away all of the interaction patterns one would expect from a visual editor, such as, dragging nodes, edge layout, connecting nodes, zooming, and panning. The graphical editor allows a user (e.g., engineer) to build a framework that works with the engineer's existing technology (e.g., JavaScript, EmberJS) that removes the need for the engineer to have to really think about how user interaction is handled.

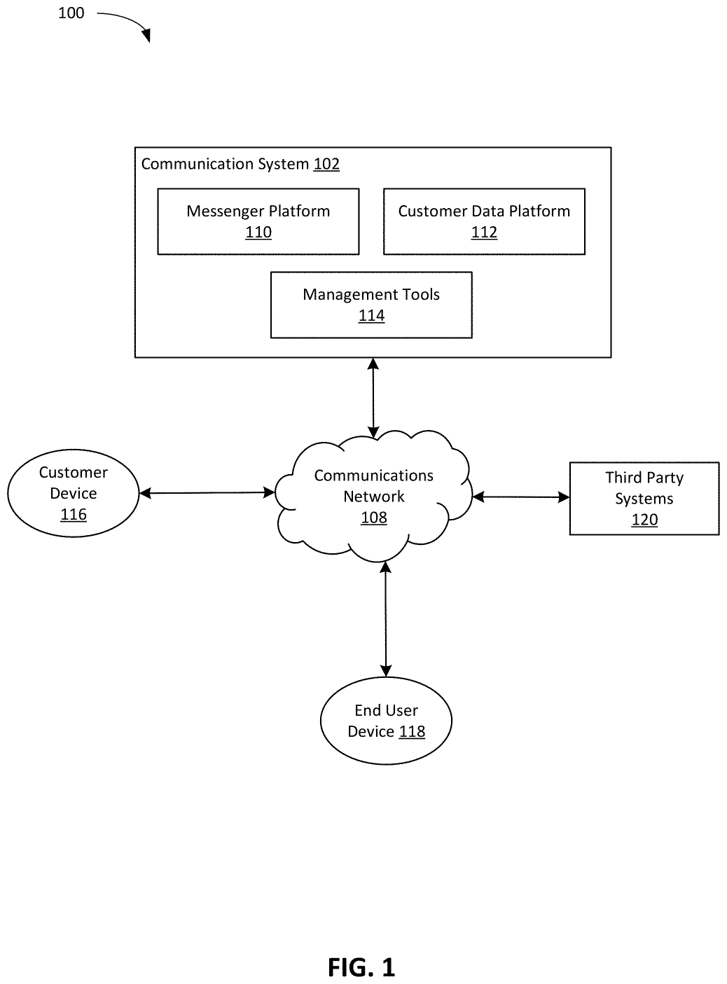

FIG. 1 is a block diagram depicting an example environment for managing communications with users and potential users of a communication system, according to some embodiments. As shown, the environment 100 includes a communication system 102 that is interconnected with a customer device 116, an end user device 118, and third party systems 120 via a communications network 108. The communications network 108 may be the internet, a wide area network (WAN), intranet, or other suitable network. The communication system 102 may be hosted on one or more local servers, may be a cloud based system, or may be a hybrid system with local servers and in the cloud. The communication system 102 is maintained by engineers which develop management tools 114 that include an interface or editor for clients of the communication system 102 to interface with the communication system 102.

The communication system 102 includes management tools 114 that are developed to allow customers to develop user series or user paths in the form of nodes (sometimes referred to as, “objects”) and edges (e.g., a connection between nodes) that are stored in a customer data platform 112 of the communication system 102. The communication system 102 includes a messenger platform 110 that interacts with user devices 118 in accordance with the user paths stored in the customer data platform 112.

A customer interacts with the communication system 102 by accessing a customer device 116. The customer device 116 may be a general purpose computer or a mobile device. The customer device 116 allows a customer to access the management tools 114 to develop the user paths stored in the customer data platform 112. For example, the customer device 116 may execute an application using its hardware (e.g., a processor, a memory) to send a request to the communication system 102 for access to a graphical editor, which is an application programming interface (API) stored in the management tools 114. In response to receiving the request, the communication system 102 may send a software package (e.g., executable code, interpreted code, programming instructions, libraries, hooks, data, etc.) to the customer device 116 to cause the customer device 116 to execute the software package using its hardware (e.g., processor, memory). In some embodiments, the application may be a desktop or mobile application, or a web application (e.g., a browser). The customer device 116 may utilize the graphical editor to build the user paths within the graphical editor. The graphical editor may periodically send copies (e.g., snapshots) of the user path as it is being built to the communication system 102, which in turn, stores the user paths to the customer data platform 112. The user paths manage communication of the customer with a user to advance the user through the user paths. The user paths may be developed to increase engagement of a user with the customer via the messenger platform 110.

The messenger platform 110 may interact with a user through an end user device 118 that accesses the communications network 108. The user device 118 may be a general purpose computer or mobile device that access the communications network 108 via the internet or a mobile network. The user may interact with the customer via a website of the customer, a messaging service, or interactive chat. In some embodiments, the user paths may allow a customer to interface with users through mobile networks via messaging or direct phone calls. In some embodiments, a customer may develop a user path in which the communication system 102 interfaces with a user device via a non-conversational channel such as email.

The communication system 102 includes programs or workers that place users into the user paths developed by the customers stored in the customer data platform 112. The communication system 102 may monitor progress of the users through the user paths developed by the customer and interact with the customer based on the nodes and edges developed by the customer for each user path. In some embodiments, the communication system 102 may remove users from user paths based on conditions developed by the customer or by the communication system 102.

The communication system 102 and/or the customers may employ third party systems 120 to receive (e.g., retrieve, obtain, acquire), update, or manipulate (e.g., modify, adjust) the customer data platform 112 or user data which is stored in the customer data platform 112. For example, a customer may utilize a third party system 120 to have a client chat directly with a user or may utilize a bot (e.g., a software program that performs automated, repetitive, and/or pre-defined tasks) to interact with a user via chat or messaging.

Although FIG. 1 shows only a select number of computing devices and/or systems (e.g., communication system 102, customer device 116, third party systems 120, and end user device 118), the environment 100 may include any number of computing devices and/or systems that are interconnected in any arrangement to facilitate the exchange of data between the computing devices and/or systems.

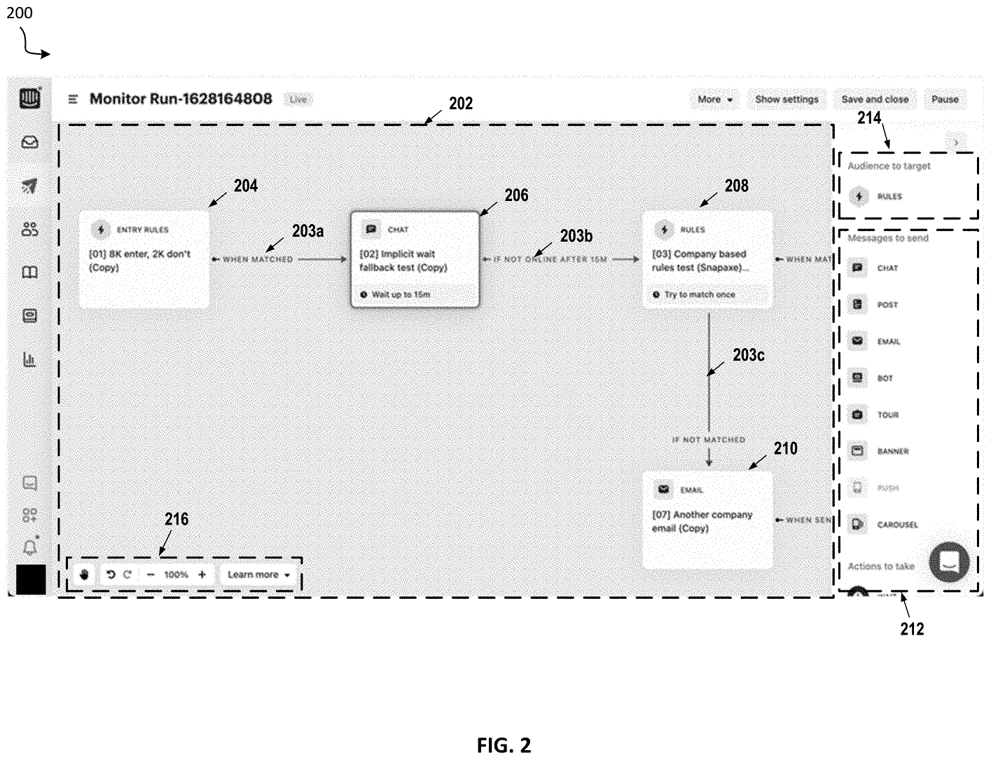

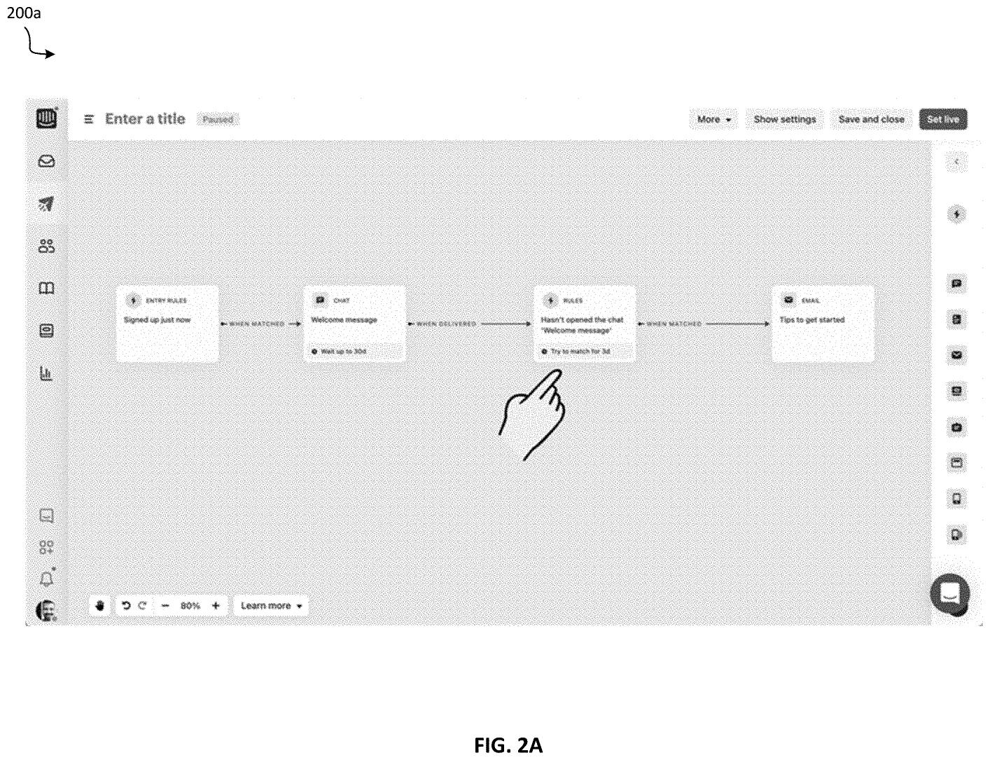

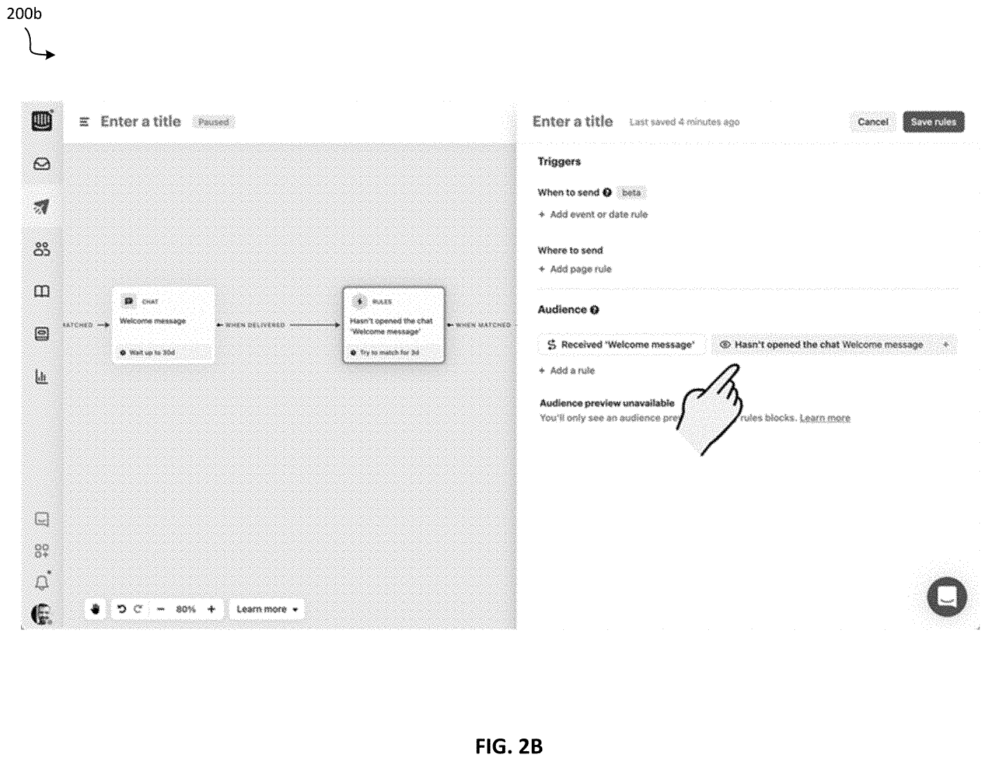

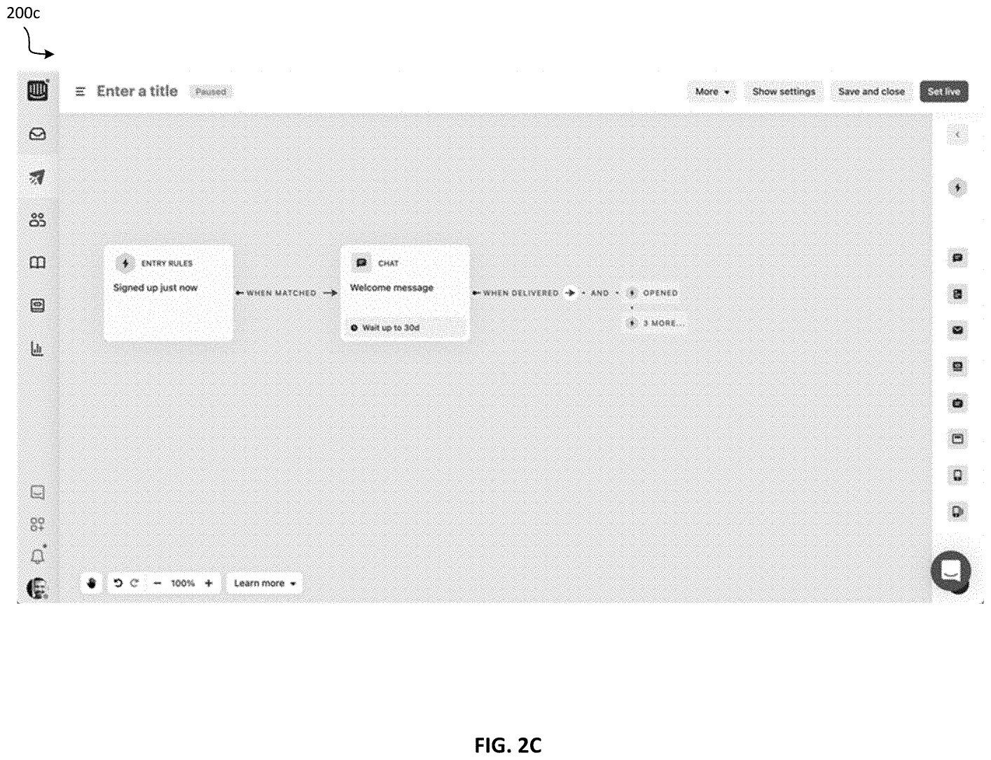

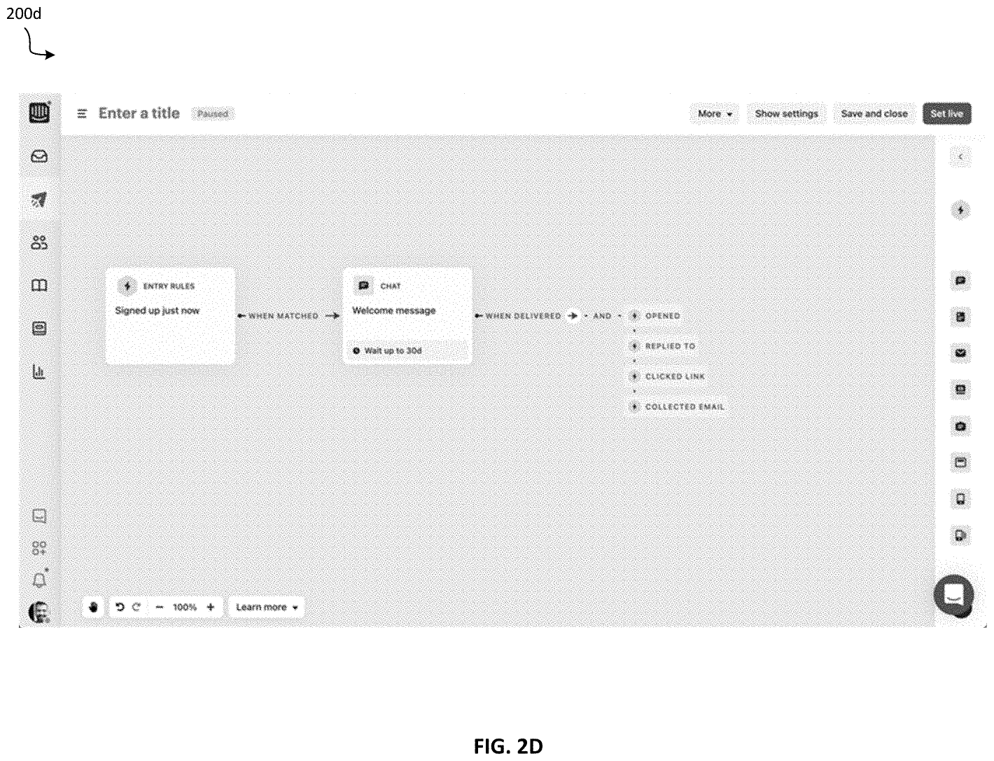

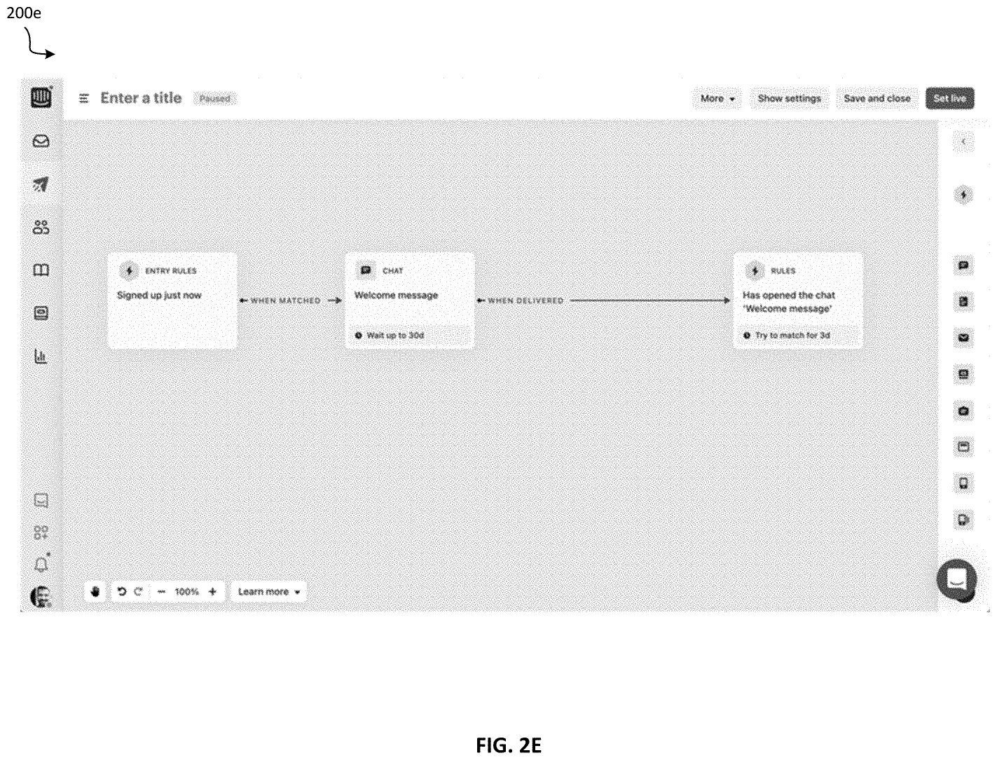

FIG. 2 is a graphical user interface of an example graphical editor depicting a method for building a series (e.g., user paths), according to some embodiments. In some embodiments, the graphical editor (sometimes referred to as, “graphical editor library”) may be configured to execute on the customer device 116, where the output of the execution is presented on a screen of the customer device 116. In some embodiments, the graphical editor may be configured to execute on the communication system 102, where the output of the execution is sent to the customer device 116 via the communications network 108 to cause the customer device 116 to display the output on a screen of the customer device 116.

As shown in FIG. 2, the graphical editor 200 includes a region 202 (sometimes referred to as, “canvas”) configured to display nodes and edges that are associated with a series. In some embodiments, a node may be a rule node (sometimes referred to as a, “filtering rule node”) that is configured to determine which paths a user should take on their journey through the series. In some embodiments, a node may be a content node that represents the actual messages the user can receive on their journey through the series. Each node includes a label (e.g., [01], [02], [03], etc.) indicating the order in which the user proceeds through the series.

The graphical editor 200 includes a rule node 204 (labeled as, “entry rules”) and a rule node 208 (labeled as, “rules”). The graphical editor 200 includes a content node 206 (labeled as, “chat”) and a content node 210 (“labeled as, “email”). The graphical editor 200 includes an edge 203a (e.g., a connection) that connects the rule node 204 to the content node 206. The graphical editor 200 includes an edge 203b that connects the content node 206 to the rule node 208. The graphical editor 200 includes an edge 203c that connects the rule node 208 to the content node 210. The edge 203a displays a condition (“when matched”) that is associated with rule node 204. The edge 203b displays a condition (“if not online after 15 minutes”) that is associated with content node 206. The edge 203c displays a condition (“if not matched”) that is associated with rule node 208.

The graphical editor 200 includes a region 214 that displays a rule node that a customer may select and drag onto the region 202 when building a series. Although the region 214 displays a single rule node, the region 214 includes an indefinite number of rule nodes that are available for the customer to drag onto the region 214.

The graphical editor 200 includes a region 212 that displays the various types of content nodes that a customer may select and drag onto the region 202 when building a series. A content node may include, for example, a chat node, a post node, an email node, a bot node, a tour node, a banner node, a push node, or a carousel node. Although the region 212 displays only a single rule node for each type of content node, the region 212 includes an indefinite number of each type of content node that are available for the customer to drag onto the region 214

The graphical editor 200 includes a region 216 that includes controls for zooming in/out of the region 202. The region 216 includes controls for panning the region 202. The region 216 includes controls for undoing any prior changes (e.g., movement of a node and/or edge, addition/deletion of a node and/or edge, rule assignment, etc.).

The inventors recognize that when it comes to lifecycle marketing, people tend to engage more with personalized content. To improve engagement, the graphical editor 200 may be configured to allow a customer to set up actions, depending on end user engagement with a previous message. For example, FIG. 2A is a block diagram of an example application (e.g., graphical editor 200) including shortcuts for content engagement predicates, according to some embodiments.

In some embodiments, the graphical editor may be configured to allow a user to open a rule block and selecting a relevant predicate. For example, FIG. 2B is a block diagram of an example application including shortcuts for content engagement predicates, according to some embodiments.

In some embodiments, the ability of the graphical editor to allow a user to open a rule block and select a relevant predicate may not be very discoverable to the user, and/or may take a bit of time. So in order to encourage people to create more personalized journeys, the graphical editor may display one or more shortcuts to add the predicates right on the canvas, when a user is hovering in an area around the message. For example, FIG. 2C is a block diagram of an example application including shortcuts for content engagement predicates, according to some embodiments.

In some embodiments, the graphical editor may be configured to allow a user to expand the list of those shortcuts. For example, FIG. 2D is a block diagram of an example application including shortcuts for content engagement predicates, according to some embodiments.

In some embodiments, the graphical editor may be configured to allow a user to add a new rule block in a single click. For example, FIG. 2E is a block diagram of an example application including shortcuts for content engagement predicates, according to some embodiments.

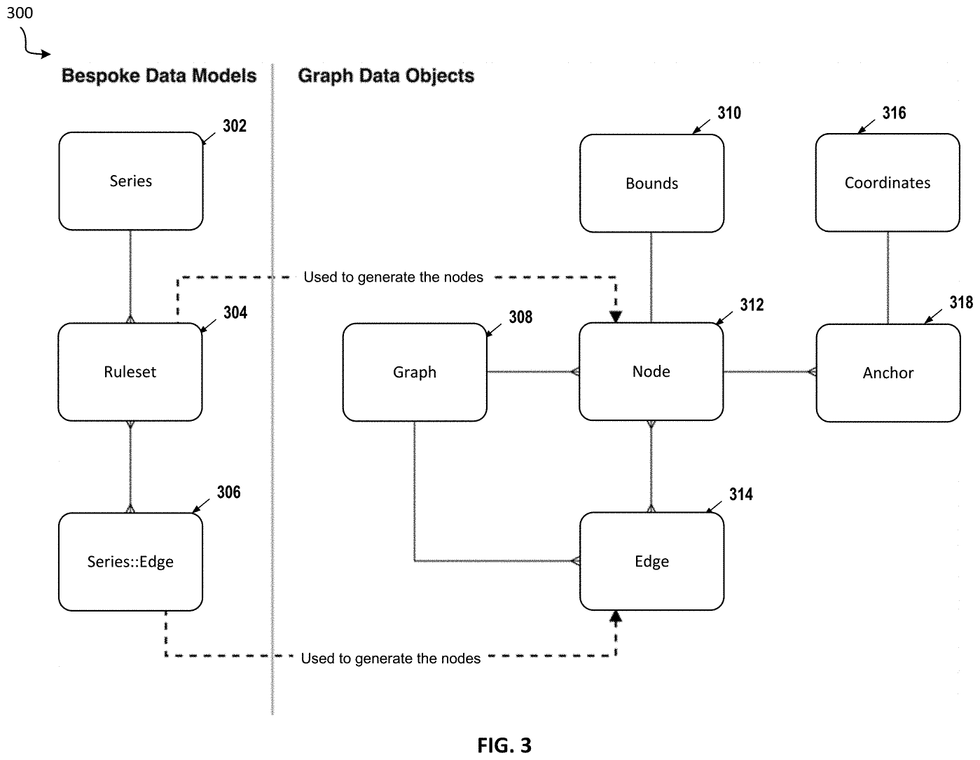

FIG. 3 is a block diagram of an example graphical editor, according to some embodiments. The graphical editor 300 (e.g., graphical editor 200) defines a set of objects (e.g., graph, node, edge) that given a bespoke graph-like data model (e.g., a series), an engineer can map (e.g., link, assign, hook) to these generic objects.

The graphical editor 300 includes bespoke data models (sometimes referred to as, “user interaction manager” or “object manager”) and graph data objects. The bespoke data models include a series object 302, a ruleset object 304, a series-edge object 306 (shown in FIG. 3 as, “Series::Edge”). The graph data objects include a graph object 308, a bounds object 310, a node object 312, an edge object 314, a coordinates object 316, and an anchor object 318. Given these generic objects, the graphical editor 300 provides a set of “Contextual Components” back to the engineer.

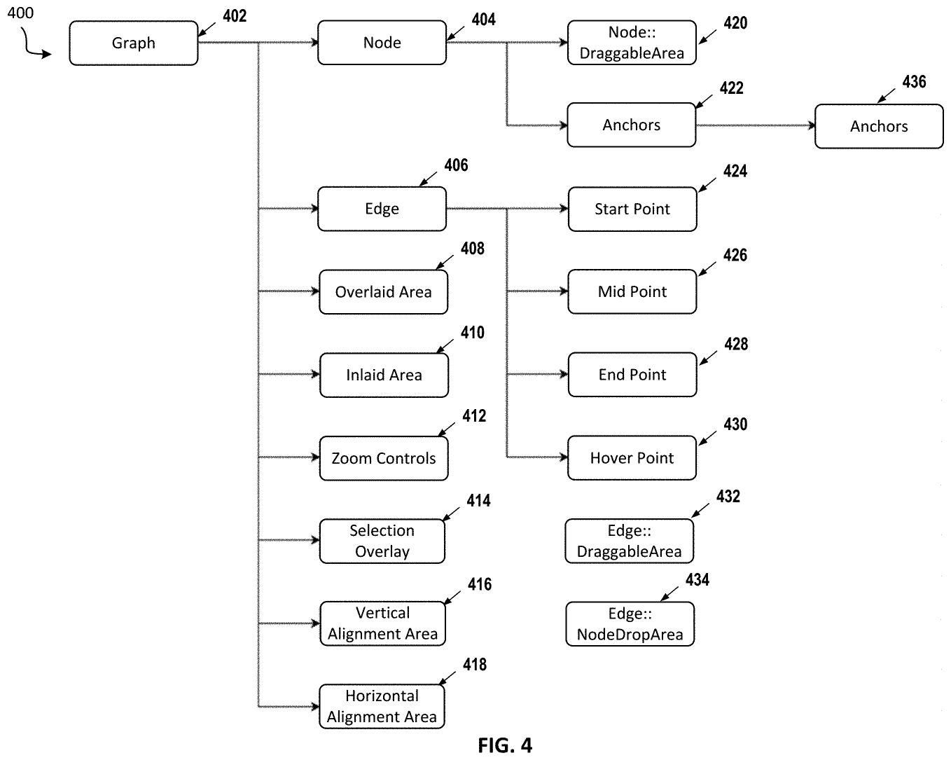

FIG. 4 is a block diagram of an example graphical editor, according to some embodiments. In some embodiments, any of the objects of the graphical editor 400 may be included in the graphical editor 300 in FIG. 3. The graph data objects include a graph object 402, a bounds object 310, a node object 404, an edge object 406, an overlaid object 408, an inland area 410 object, a zoom controls object 412, a selection overlay object 414, a vertical alignment area object 416, a horizontal alignment area object 418, a node draggable area object 420, an anchors object 422, a start point object 424, a mid-point object 426, an end point object 428, a hover point object 430, an edge draggable area object 432, an edge node drop area object 434, and an anchor object 436. In some embodiments, the edge node drop area object 434 and the anchor object 436 are associated with the bespoke data models in FIG. 3, and the remaining objects in FIG. 4 are associated with the graph object 308, the node object 312, and the edge object 314 in FIG. 3

With these objects (sometimes referred to as, “components”), an engineer can compose their own UI in any way they want, where the core logic of how to handle the user interactions (e.g., panning/mouse, movement/zooming, rerouting of edges when moving/adding/deleting nodes on canvas) is handled internally by the graph editor (e.g., graphical editor 200, graphical editor 300, graphical editor 400).

In some embodiments, for performance reasons, the graph editor may be configured to calculate the layout of the edges in memory (e.g., with an algorithm to prevent edges going straight through nodes) and then generate a single scalable vector graphics (SVG) which a browser can easily render. In some embodiments, a node may be configured to use cascading style sheets (CSS) transforms to place themselves at the correct position on the canvas. In some embodiments, updates may be provided back through a series of “hooks” that the engineer can setup. In some embodiments, the hooks may control how the data flows between the generic “Graph Editor” and whatever bespoke data models it represents (e.g. a Series).

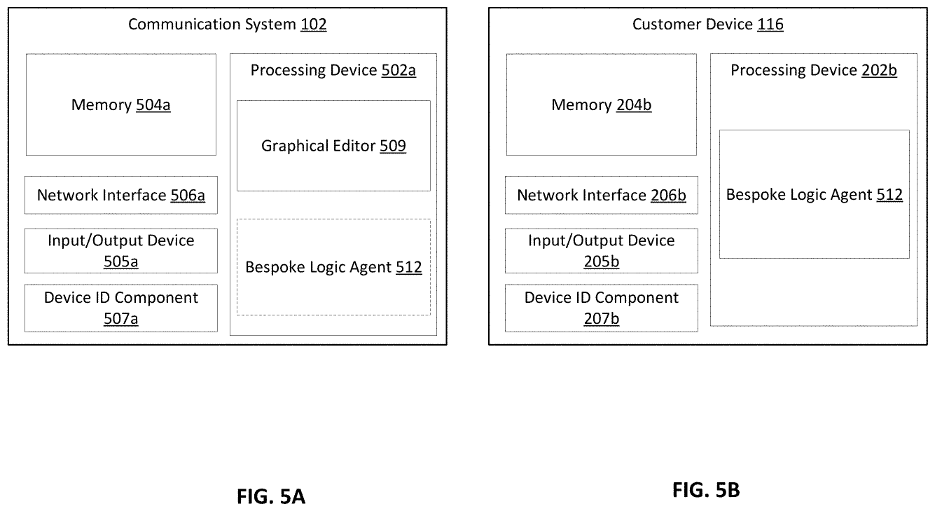

FIG. 5A is a block diagram depicting an example of the communication system 102 in FIG. 1, according to some embodiments. While various devices, interfaces, and logic with particular functionality are shown, it should be understood that the communication system 102 includes any number of devices and/or components, interfaces, and logic for facilitating the functions described herein. For example, the activities of multiple devices may be combined as a single device and implemented on a same processing device (e.g., processing device 202a), as additional devices and/or components with additional functionality are included.

The communication system 102 includes a processing device 502a (e.g., general purpose processor, a PLD, etc.), which may be composed of one or more processors, and a memory 504a (e.g., synchronous dynamic random access memory (DRAM), read-only memory (ROM)), which may communicate with each other via a bus (not shown).

The processing device 502a may be provided by one or more general-purpose processing devices such as a microprocessor, central processing unit, or the like. In some embodiments, processing device 502a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 502a may comprise one or more special-purpose processing devices such as an application specific integrated circuit (ASIC), a field programmable gate array (FPGA), a digital signal processor (DSP), network processor, or the like. The processing device 502a may be configured to execute the operations described herein, in accordance with one or more aspects of the present disclosure, for performing the operations and steps discussed herein.

The memory 504a (e.g., Random Access Memory (RAM), Read-Only Memory (ROM), Non-volatile RAM (NVRAM), Flash Memory, hard disk storage, optical media, etc.) of processing device 502a stores data and/or computer instructions/code for facilitating at least some of the various processes described herein. The memory 504a includes tangible, non-transient volatile memory, or non-volatile memory. The memory 504a stores programming logic (e.g., instructions/code) that, when executed by the processing device 502a, controls the operations of the communication system 102. In some embodiments, the processing device 502a and the memory 504a form various processing devices and/or circuits described with respect to the communication system 102. The instructions include code from any suitable computer programming language such as, but not limited to, C, C++, C#, Java, JavaScript, VBScript, Perl, HTML, XML, Python, TCL, and Basic.

The processing device 202a may include and/or execute a graphical editor 509 (e.g., an application) that is displayed on a computer screen of the communication system 102. In some embodiments, the graphical editor 509 may be configured to present a canvas and a plurality of nodes together on a display of the communication system 102. In some embodiments, the graphical editor 509 may be configured to send an output of the execution to the customer device 116 via the communications network 108 to cause the customer device 116 to display the output on a screen of the customer device 116.

The graphical editor 509 may be configured to configure (e.g., implement, setup) a plurality of hooks to control communication between the communication system 102 and a bespoke logic agent 512. The processing device 202a may be configured to execute the bespoke logic agent 512. Alternatively, a processing device (e.g., processing device 505b) of the customer device 116 may be configured to execute the bespoke logic agent 512.

The graphical editor 509 may be configured to detect a request to perform a particular type (e.g., a first type) of action that is associated with at least a canvas or a node of the plurality of nodes. The graphical editor 509 may detect a request to perform a particular type of action if a user interacts with a node using a mouse cursor or keystroke by, for example, clicking on a node, hovering over a node, or dragging a node across the canvas. For example, a user may drag a new edge from one node to another, and when the user places the mouse cursor over another node, then the graphical editor 509 detects a request to insert an edge. Types of actions include, for example, adding a node to a canvas, deleting a node from a canvas, dragging a node across the canvas, and adding a connection between nodes.

The graphical editor 509 may be configured to acquire information from the bespoke logic agent 512 via a first hook of the plurality of hooks that is associated with the first type of action. The graphical editor 509 may be configured to determine whether to grant or deny the request to perform the first type of action based on the information. The graphical editor 509 may be configured to grant the request to perform the first type of action responsive to determining to grant the request to perform the first type of action. The graphical editor 509 may be configured to deny the request to perform the first type of action responsive to determining to deny the request to perform the first type of action.

The graphical editor 509 may be configured to determine that the first type of action is to insert or overlay an additional node onto the canvas. The graphical editor 509 may be configured to add the additional node to a graph data structure that is associated with the canvas responsive to determining to grant the request to perform the first type of action. In some embodiments, the graphical editor 509 internally maintains the graph data structure. The graphical editor 509 may be configured to send, via the first hook of the plurality of hooks, a message to the bespoke logic agent 512 to cause the bespoke logic agent 512 to update a ruleset that is associated with the plurality of nodes. That is, the communication system 102 (or customer device 116) may use the ruleset to generate the additional node on the canvas.

The graphical editor 509 may be configured to prevent the additional node from being added to the canvas responsive to determining to deny the request to perform the first type of action. For example, the graphical editor 509 may be configured to cancel one or more events associated with the graphical editor 509 (or a web browser) responsive to determining to deny the request to perform the first type of action.

The graphical editor 509 may be configured to determine that the first type of action is to delete one or more nodes of the plurality of nodes from the canvas. The graphical editor 509 may be configured to delete the one or more nodes from a graph data structure associated with the canvas responsive to determining to grant the request to perform the first type of action. The graphical editor 509 may be configured to send, via the first hook of the plurality of hooks, a message to the bespoke logic agent 512 to cause the bespoke logic agent 512 to delete a ruleset that is associated with the one or more nodes of the plurality of nodes.

The graphical editor 509 may be configured to determine that the first type of action is to add a connection between a first node of the plurality of nodes and a second node of the plurality of nodes. The graphical editor 509 may be configured to add the connection to a graph data structure associated with the canvas responsive to determining to grant the request to perform the first type of action. The graphical editor 509 may be configured to send, via the first hook of the plurality of hooks responsive to adding the connection to the graph data structure, a message to the bespoke logic agent 512 to cause the bespoke logic agent 512 to update a ruleset that is associated with the plurality of nodes. The graphical editor 509 may be configured to send, via the first hook of the plurality of hooks responsive to adding the connection to the graph data structure, a message to the bespoke logic agent 512 to cause the bespoke logic agent 512 to connect a first ruleset associated with the first node to a second ruleset associated with the second node.

The graphical editor 509 may be configured to detect a second request to perform a second type of action associated with at least the canvas or a node of the plurality of nodes. The graphical editor 509 may be configured to acquire information from the bespoke logic agent 512 via a second hook of the plurality of hooks that is associated with the second type of action. The graphical editor 509 may be configured to determine whether to grant or deny the second request to perform the second type of action based on the information. The graphical editor 509 may be configured to grant the second request to perform the second type of action responsive to determining to grant the second request to perform the second type of action. The graphical editor 509 may be configured to deny the second request to perform the second type of action responsive to determining to deny the second request to perform the second type of action.

The graphical editor 509 may be configured to detect an additional request to perform the first type of action associated with at least the canvas or a node of the plurality of nodes. The graphical editor 509 may be configured to acquire additional information from the bespoke logic via the first hook of the plurality of hooks. The graphical editor 509 may be configured to determine whether to grant or deny the additional request to perform the first type of action based on the additional information. The graphical editor 509 may be configured to grant the additional request to perform the first type of action responsive to determining to grant the additional request to perform the first type of action. The graphical editor 509 may be configured to deny the additional request to perform the first type of action responsive to determining to deny the additional request to perform the first type of action.

The graphical editor 509 may be configured to acquire information from the bespoke logic via the first hook of the plurality of hooks that is associated with the first type of action includes mapping the information from a first data format to a second data format.

The communication system 102 includes a network interface 206a configured to establish a communication session with a computing device for sending and receiving data over the communications network 108 to the computing device. Accordingly, the network interface 206A includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the communication system 102 includes a plurality of network interfaces 206a of different types, allowing for connections to a variety of networks, such as local area networks (public or private) or wide area networks including the Internet, via different sub-networks.

The communication system 102 includes an input/output device 205a configured to receive user input from and provide information to a user. In this regard, the input/output device 205a is structured to exchange data, communications, instructions, etc. with an input/output component of the communication system 102. Accordingly, input/output device 205a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of communication system 102, such as a built-in display, touch screen, microphone, etc., or external to the housing of communication system 102, such as a monitor connected to communication system 102, a speaker connected to communication system 102, etc., according to various embodiments. In some embodiments, the communication system 102 includes communication circuitry for facilitating the exchange of data, values, messages, and the like between the input/output device 205a and the components of the communication system 102. In some embodiments, the input/output device 205a includes machine-readable media for facilitating the exchange of information between the input/output device 205a and the components of the communication system 102. In still another embodiment, the input/output device 205a includes any combination of hardware components (e.g., a touchscreen), communication circuitry, and machine-readable media.

The communication system 102 includes a device identification component 207a (shown in FIG. 2A as device ID component 207a) configured to generate and/or manage a device identifier associated with the communication system 102. The device identifier may include any type and form of identification used to distinguish the communication system 102 from other computing devices. In some embodiments, to preserve privacy, the device identifier may be cryptographically generated, encrypted, or otherwise obfuscated by any device and/or component of communication system 102. In some embodiments, the communication system 102 may include the device identifier in any communication (e.g., a message that includes the container image request, etc.) that the communication system 102 sends to a computing device.

The communication system 102 includes a bus (not shown), such as an address/data bus or other communication mechanism for communicating information, which interconnects the devices and/or components of communication system 102, such as processing device 202a , network interface 206a, input/output device 205a, and device ID component 207a.

In some embodiments, some or all of the devices and/or components of communication system 102 may be implemented with the processing device 202a. For example, the communication system 102 may be implemented as a software application stored within the memory 204a and executed by the processing device 202a. Accordingly, such embodiment can be implemented with minimal or no additional hardware costs. In some embodiments, any of these above-recited devices and/or components rely on dedicated hardware specifically configured for performing operations of the devices and/or components.

FIG. 5B is a block diagram depicting an example of the customer device 116 of the environment in FIG. 1, according to some embodiments. While various devices, interfaces, and logic with particular functionality are shown, it should be understood that the customer device 116 includes any number of devices and/or components, interfaces, and logic for facilitating the functions described herein. For example, the activities of multiple devices may be combined as a single device and implemented on a same processing device (e.g., processing device 202b), as additional devices and/or components with additional functionality are included.

The customer device 116 includes a processing device 202b (e.g., general purpose processor, a PLD, etc.), which may be composed of one or more processors, and a memory 204b (e.g., synchronous dynamic random access memory (DRAM), read-only memory (ROM)), which may communicate with each other via a bus (not shown). The processing device 202b includes identical or nearly identical functionality as processing device 202a in FIG. 2a, but with respect to devices and/or components of the customer device 116 instead of devices and/or components of the communication system 102.

The memory 204b of processing device 202b stores data and/or computer instructions/code for facilitating at least some of the various processes described herein. The memory 204b includes identical or nearly identical functionality as memory 204a in FIG. 2A, but with respect to devices and/or components of the customer device 116 instead of devices and/or components of the communication system 102.

The processing device 202b may be configured to execute a bespoke logic agent 512 that is configured to receive a message from the communication system 102, where the message includes instructions for installing (e.g., configuring) one or more hooks to allow the communication system 102 to control communication between the communication system 102 and the bespoke logic agent 512. That is, a hook is a point in the system message-handling mechanism where an application can install a subroutine to monitor the message traffic in the system and process certain types of messages before they reach the target window procedure. The instructions cause the bespoke logic agent 512 (or the processing device 202b of the customer device) to install the one or more hooks on the customer device 116.

The processing device 202b may be configured to allow the communication system 102 to acquire information from the bespoke logic agent 512 via a hook of the plurality of hooks, where the hook is associated with a particular type of action. For example, the communication system 102 may acquire a first set of information from the bespoke logic agent 512 via a first hook of the plurality of hooks, where the first hook is associated with a first type of action. The communication system 102 may also acquire a second set of information from the bespoke logic agent 512 via a second hook of the plurality of hooks, where the second hook is associated with a second type of action.

In some embodiments, the bespoke logic agent 512 sends information to the communication system 102 via a particular hook that is associated with a particular type of action. For example, bespoke logic agent 512 sends the first set of information to the communication system 102 via the first hook of the plurality of hooks, and sends the second set of information to the communication system 102 via the second hook of the plurality of hooks.

In some embodiments, the communication system 102 acquires information from the bespoke logic agent 512 via a particular hook (e.g., a first hook) of the plurality of hooks that is associated with a particular type of action (e.g., a first type) by mapping (e.g., translating, converting) the information from a first data format to a second data format.

The processing device 202b may be configured to receive, via a hook (e.g., a first hook) of the plurality of hooks, a message from the communication system 102 that causes the bespoke logic agent 512 to update a ruleset that is associated with one or more nodes (or all) of the plurality of nodes.

The processing device 202b may be configured to receive, via a hook (e.g., a first hook) of the plurality of hooks, a message from the communication system 102 that causes the bespoke logic agent 512 to delete (e.g., remove) a ruleset that is associated with the one or more nodes (or all) of the plurality of nodes.

The processing device 202b may be configured to receive, via a hook (e.g., a first hook) of the plurality of hooks responsive to adding a connection to a graph data structure, a message from the communication system 102 that causes the bespoke logic agent 512 to connect a first ruleset associated with the first node to a second ruleset that I associated with the second node.

The customer device 116 includes a network interface 206b configured to establish a communication session with a computing device for sending and receiving data over a network to the computing device. Accordingly, the network interface 206b includes identical or nearly identical functionality as network interface 206a in FIG. 2A, but with respect to devices and/or components of the customer device 116 instead of devices and/or components of the communication system 102.

The customer device 116 includes an input/output device 205b configured to receive user input from and provide information to a user. In this regard, the input/output device 205b is structured to exchange data, communications, instructions, etc. with an input/output component of the customer device 116. The input/output device 205b includes identical or nearly identical functionality as input/output processor 205a in FIG. 2A, but with respect to devices and/or components of the customer device 116 instead of devices and/or components of the communication system 102.

The customer device 116 includes a device identification component 207b (shown in FIG. 2B as device ID component 207b) configured to generate and/or manage a device identifier associated with the customer device 116. The device ID component 207b includes identical or nearly identical functionality as device ID component 207a in FIG. 2A, but with respect to devices and/or components of the customer device 116 instead of devices and/or components of the communication system 102.

The customer device 116 includes a bus (not shown), such as an address/data bus or other communication mechanism for communicating information, which interconnects the devices and/or components of the customer device 116, such as processing device 202b, network interface 206b, input/output device 205b, and device ID component 207b.

In some embodiments, some or all of the devices and/or components of customer device 116 may be implemented with the processing device 202b. For example, the customer device 116 may be implemented as a software application stored within the memory 204b and executed by the processing device 202b. Accordingly, such embodiment can be implemented with minimal or no additional hardware costs. In some embodiments, any of these above-recited devices and/or components rely on dedicated hardware specifically configured for performing operations of the devices and/or components.

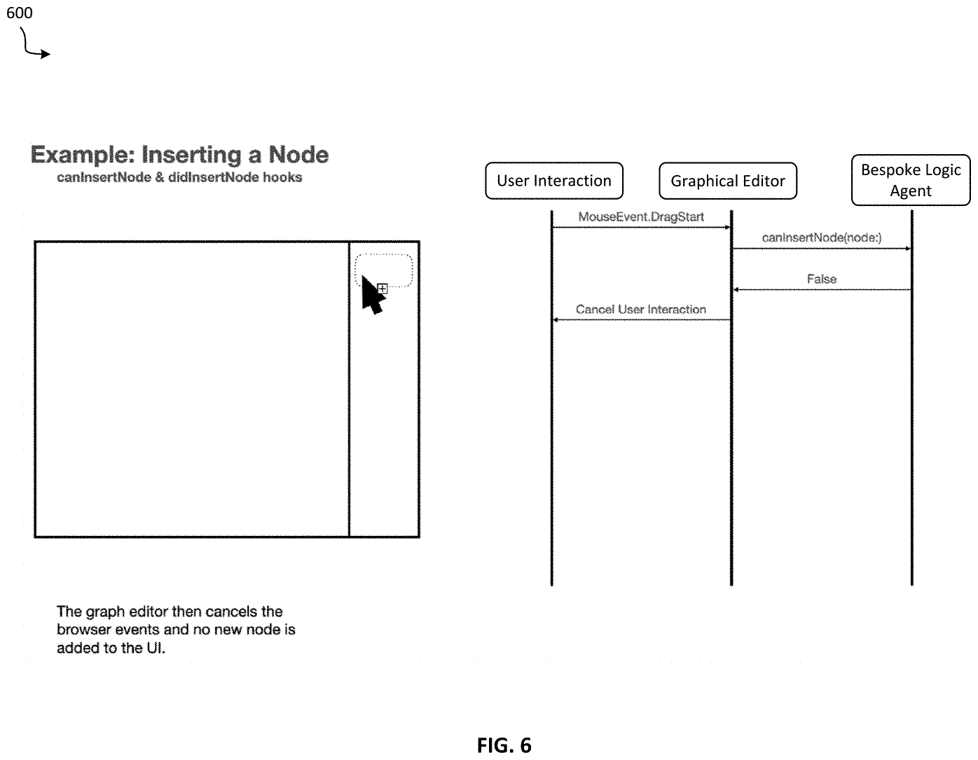

FIG. 6 is a flow diagram depicting a method for managing user interactions associated with inserting a node into a graphical user interface, according to some embodiments. The method 600 may be performed by a graphical editor library (e.g., graphical editor 200, graphical editor 300, graphical editor 400) executing on processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the graphical editor may execute on the communication system 102, the customer device 116, the end user device 118, or the third party system 120 in FIG. 1.

In some embodiments, the method 600 may include an operation where a user (e.g., customer) of a graphical editor begins dragging a new node onto the canvas of the graphical editor. In some embodiments, the method 600 may include an operation where a DragStart event is fired (e.g., launched, triggered). In some embodiments, the event contains a reference to the type of node that the user is trying to insert into the canvas.

In some embodiments, the method 600 may include an operation where the graphical editor library extracts the data of the type of node that is being inserted and then invokes the canInsertNode hook. In some embodiments, the method 600 may include an operation where the engineer who has built their UI with the graphical editor library can implement bespoke logic agent which determines whether a user can or cannot insert a node. In some embodiments, the graphical editor may include the bespoke logic agent. In some embodiments, the bespoke logic agent may be a separate application that executes on a processor of a computing device, where the bespoke logic agent has its hooks installed in the graphical editor for monitoring and/or detecting user interaction with objects (e.g., nodes) of the graphical editor, as well as, sending instructions (e.g., permitting dragging/inserting of a node onto a canvas, denying the dragging/inserting of a node onto a canvas, etc.) back to the graphical editor.

In some embodiments, the method 600 may include an operation where the bespoke logic agent determines that the user cannot add a new node (as indicated by the “false” flag), and in response to this determination, the graph editor may cancel the browser events and no new node is added to the UI.

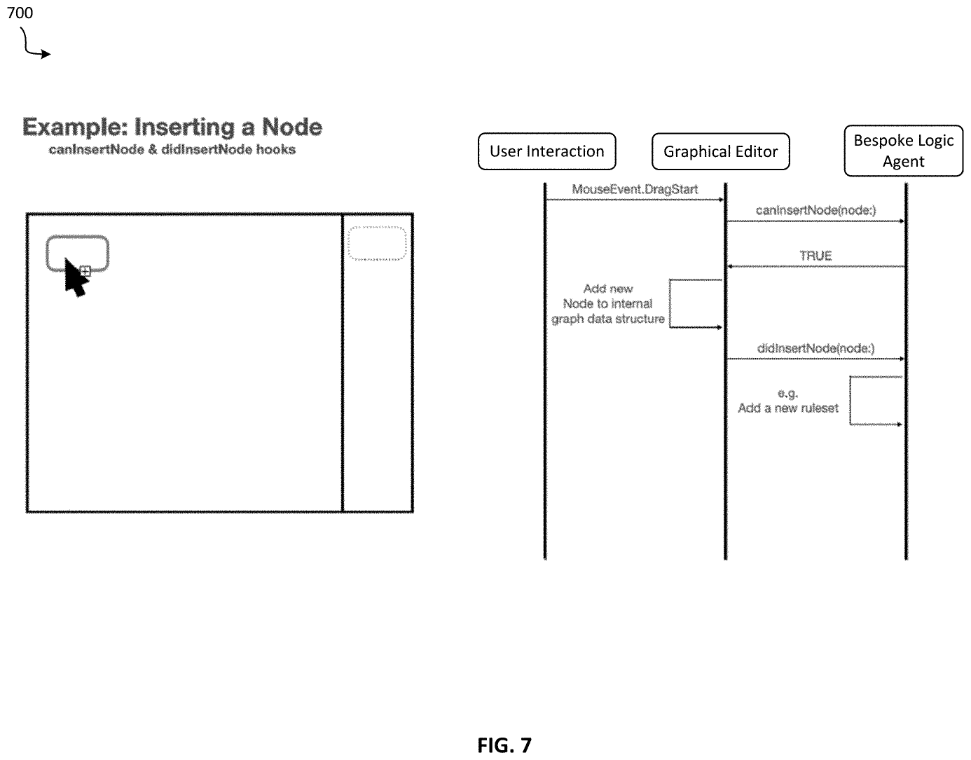

FIG. 7 is a flow diagram depicting a method for managing user interactions associated with inserting a node into a graphical user interface, according to some embodiments. That is, the method 700 describes what would happen if the bespoke logic agent determines that the user can add a new node. The method 700 may be performed by a graphical editor library (e.g., graphical editor 200, graphical editor 300, graphical editor 400) executing on processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the graphical editor may execute on the communication system 102, the customer device 116, or the third party system 120 in FIG. 1.

In some embodiments, the method 700 may include an operation where the bespoke logic agent determines that the user can add a new node (as indicated by the “true” flag), and in response to this determination, the graph editor may update its internal representation of the graph data structure.

In some embodiments, the method 700 may include an operation where the graphical editor informs the bespoke logic agent that a new node has been added. In some embodiments, the graphical editor can choose to update its own data model accordingly. For example, the graphical editor would update the series data model with a new ruleset node.

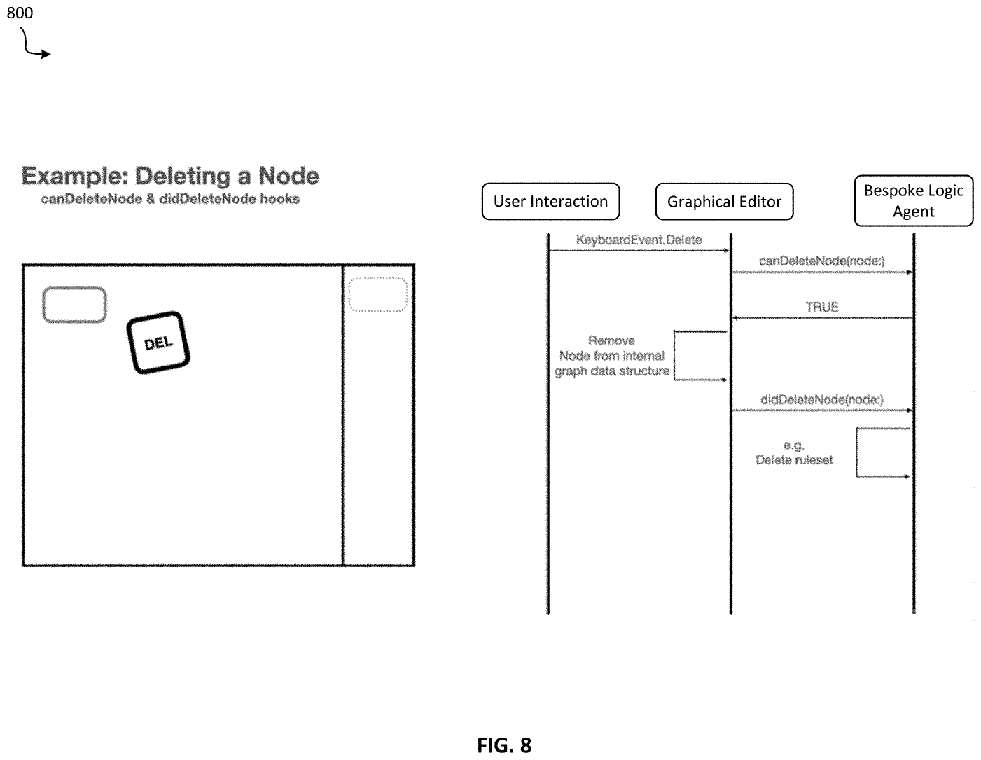

FIG. 8 is a flow diagram depicting a method for managing user interactions associated with deleting a node in a graphical user interface, according to some embodiments. The method 800 may be performed by a graphical editor library (e.g., graphical editor 200, graphical editor 300, graphical editor 400) executing on processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the graphical editor may execute on the communication system 102, the customer device 116, or the third party system 120 in FIG. 1.

In some embodiments, the method 800 may include an operation where the graphical editor is handling keyboard events. In some embodiments, the method 800 may include an operation where the graphical editor mat determine that a DELETE keyboard event has occurred or has been received, in response, the graphical editor library may determine whether one or more selected nodes can be deleted by invoking the canDeleteNode hook.

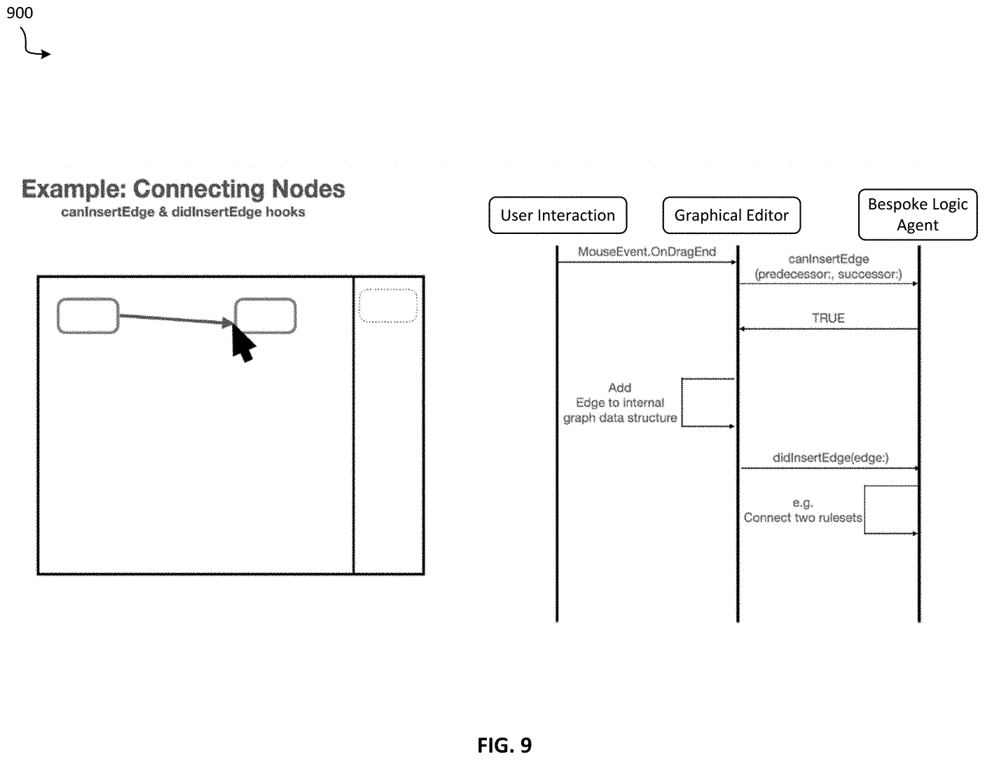

FIG. 9 is a flow diagram depicting a method for managing user interactions associated with connecting node in a graphical user interface, according to some embodiments. The method 900 may be performed by a graphical editor library (e.g., graphical editor 200, graphical editor 300, graphical editor 400) executing on processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the graphical editor may execute on the communication system 102, the customer device 116, or the third party system 120 in FIG. 1.

In some embodiments, the method 900 may include an operation where a user may drag a new edge from one node to another. In some embodiments, the method 900 may include an operation where the graphical user library determines that they mouse-up over another node, and in response, the graph editor library may invoke the ‘canInsertEdge’ hook and/or the didInsertEdge hook.

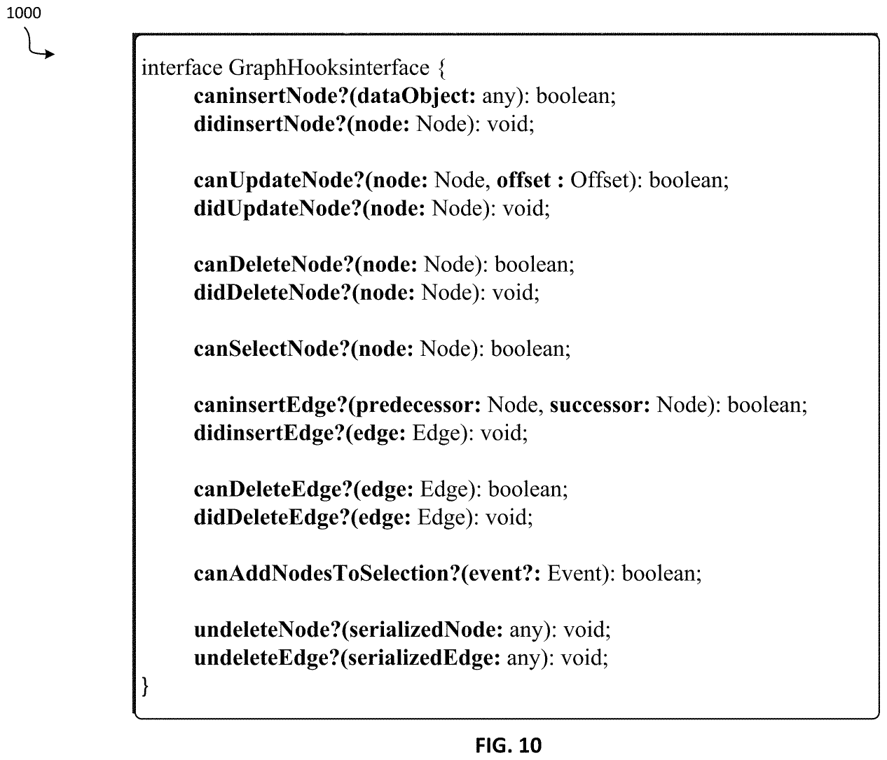

FIG. 10 is a screen capture of an example list of hooks, according to some embodiments. The graphical editor library executing on the communication system 102 or customer device 116 may invoke one or more hooks to cause the hooks to execute on the communication system 102 or customer device 116. The graphical editor library may invoke a canInsertNode hook that is configured to determine whether a user has permission to insert a node. The graphical editor library may invoke a canUpdateNode hook to determine whether a user has permission to update a node on a canvas. The graphical editor library may invoke a canDeleteNode hook that is configured to determine whether a user has permission to delete a node from a canvas. The graphical editor library may invoke a canSelectNode hook that is configured to determine whether a user has permission to select (e.g., with a mouse cursor, a keystroke) a node on a canvas. The graphical editor library may invoke a canAddNode hook that is configured to determine whether a user has permission to add a node to a canvas. The graphical editor library may invoke undeleteNode hook that is configured to determine whether a user has permission to undelete a node.

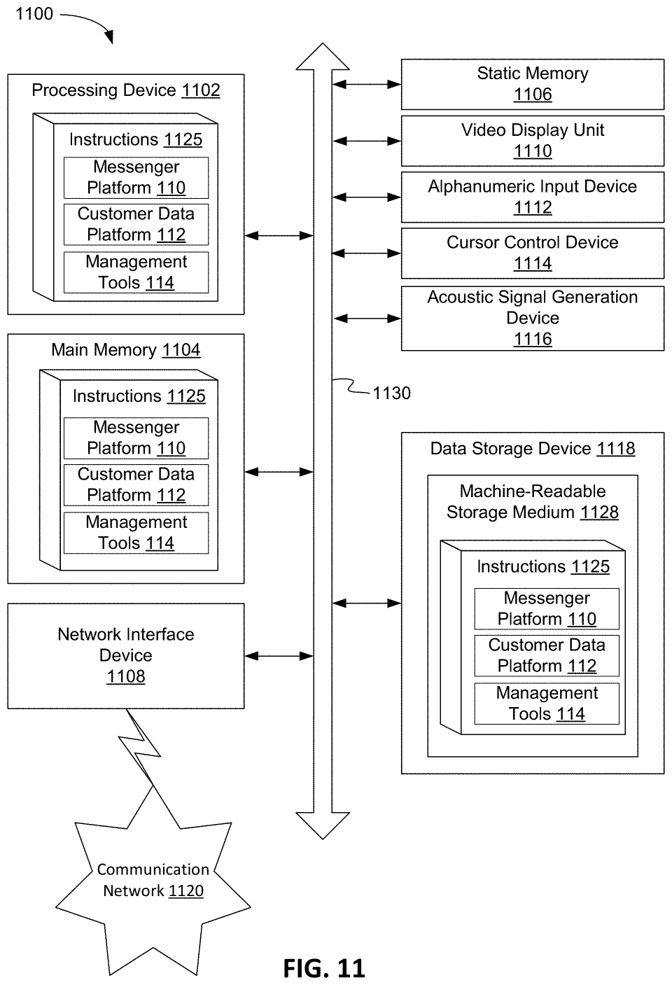

FIG. 11 is a block diagram of an example computing device 1100 that may perform one or more of the operations described herein, in accordance with some embodiments. Computing device 1100 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1100 may include a processing device (e.g., a general purpose processor, a PLD, etc.) 1102, a main memory 1104 (e.g., synchronous dynamic random access memory (DRAM), read-only memory (ROM)), a static memory 1106 (e.g., flash memory and a data storage device 1118), which may communicate with each other via a bus 1130.

Processing device 1102 may be provided by one or more general-purpose processing devices such as a microprocessor, central processing unit, or the like. In an illustrative example, processing device 1102 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1102 may comprise one or more special-purpose processing devices such as an application specific integrated circuit (ASIC), a field programmable gate array (FPGA), a digital signal processor (DSP), network processor, or the like. The processing device 1102 may be configured to execute the operations described herein, in accordance with one or more aspects of the present disclosure, for performing the operations and steps discussed herein.

Computing device 1100 may further include a network interface device 1108 which may communicate with a communications network 1120. The computing device 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse) and an acoustic signal generation device 1116 (e.g., a speaker). In one embodiment, video display unit 1110, alphanumeric input device 1112, and cursor control device 1114 may be combined into a single component or device (e.g., an LCD touch screen).

Data storage device 1118 may include a computer-readable storage medium 1128 on which may be stored one or more sets of instructions 1125 that may include instructions for one or more components (e.g., messenger platform 110, the customer data platform 112, and the management tools 114) for carrying out the operations described herein, in accordance with one or more aspects of the present disclosure. Instructions 1125 may also reside, completely or at least partially, within main memory 1104 and/or within processing device 1102 during execution thereof by computing device 1100, main memory 1104 and processing device 1102 also constituting computer-readable media. The instructions 1125 may further be transmitted or received over a communication network 1120 via network interface device 1108.

While computer-readable storage medium 1128 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “executing,” “configuring,” “detecting,” “acquiring,” “determining,” “granting,” “denying,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein may relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. The terms “comprises”, “comprising”, “includes”, and/or “including”, when used herein, may specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

In some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

What is claimed is:

1. A method comprising:
executing an application to cause the application to present a canvas and a plurality of nodes together on a display;
configuring a plurality of hooks to control communication associated with bespoke logic;
detecting a request to perform a first type of action associated with at least the canvas or a node of the plurality of nodes;
acquiring, by a processing device, information from the bespoke logic via a first hook of the plurality of hooks that is associated with the first type of action;
determining whether to grant or deny the request to perform the first type of action based on the information; and
granting the request to perform the first type of action responsive to determining to grant the request to perform the first type of action, or
denying the request to perform the first type of action responsive to determining to deny the request to perform the first type of action.

2. The method of claim 1, further comprising:
determining that the first type of action is to insert an additional node onto the canvas; and
adding the additional node to a graph data structure associated with the canvas responsive to determining to grant the request to perform the first type of action.

3. The method of claim 2, further comprising:
sending, via the first hook of the plurality of hooks, a message to the bespoke logic to cause the bespoke logic to update a ruleset associated with the plurality of nodes.

4. The method of claim 1, further comprising:
canceling one or more events associated with the application responsive to determining to deny the request to perform the first type of action.

5. The method of claim 1, comprising:
determining that the first type of action is to delete one or more nodes of the plurality of nodes from the canvas; and
deleting the one or more nodes from a graph data structure associated with the canvas responsive to determining to grant the request to perform the first type of action.

6. The method of claim 5, further comprising:
sending, via the first hook of the plurality of hooks, a message to the bespoke logic to cause the bespoke logic to delete a ruleset associated with the one or more nodes of the plurality of nodes.

7. The method of claim 1, comprising:
determining that the first type of action is to add a connection between a first node of the plurality of nodes and a second node of the plurality of nodes;
adding the connection to a graph data structure associated with the canvas responsive to determining to grant the request to perform the first type of action.

8. The method of claim 7, further comprising:
sending, via the first hook of the plurality of hooks responsive to adding the connection to the graph data structure, a message to the bespoke logic to cause the bespoke logic to connect a first ruleset associated with the first node to a second ruleset associated with the second node.

9. The method of claim 1, further comprising:
detecting a second request to perform a second type of action associated with at least the canvas or a node of the plurality of nodes;
acquiring information from the bespoke logic via a second hook of the plurality of hooks that is associated with the second type of action;
determining whether to grant or deny the second request to perform the second type of action based on the information; and
granting the second request to perform the second type of action responsive to determining to grant the second request to perform the second type of action, or denying the second request to perform the second type of action responsive to determining to deny the second request to perform the second type of action.

10. The method of claim 9, further comprising:
detecting an additional request to perform the first type of action associated with at least the canvas or a node of the plurality of nodes;
acquiring additional information from the bespoke logic via the first hook of the plurality of hooks;
determining whether to grant or deny the additional request to perform the first type of action based on the additional information; and
granting the additional request to perform the first type of action responsive to determining to grant the additional request to perform the first type of action, or
denying the additional request to perform the first type of action responsive to determining to deny the additional request to perform the first type of action.

11. The method of claim 1, wherein acquiring information from the bespoke logic via the first hook of the plurality of hooks that is associated with the first type of action comprising:
mapping the information from a first data format to a second data format.

12. A system comprising:
a memory; and
a processing device, operatively coupled to the memory, to:
execute an application to cause the application to present a canvas and a plurality of nodes together on a display;
configure a plurality of hooks to control communication associated with bespoke logic;
detect a request to perform a first type of action associated with at least the canvas or a node of the plurality of nodes;
acquire information from the bespoke logic via a first hook of the plurality of hooks that is associated with the first type of action;
determine whether to grant or deny the request to perform the first type of action based on the information; and
grant the request to perform the first type of action responsive to determining to grant the request to perform the first type of action, or
deny the request to perform the first type of action responsive to determining to deny the request to perform the first type of action.

13. The system of claim 12, wherein the processing device further to:
determine that the first type of action is to insert an additional node onto the canvas; and
add the additional node to a graph data structure associated with the canvas responsive to determining to grant the request to perform the first type of action.

14. The system of claim 13, wherein the processing device further to:
send, via the first hook of the plurality of hooks, a message to the bespoke logic to cause the bespoke logic to update a ruleset associated with the plurality of nodes.

15. The system of claim 12, wherein the processing device further to:
cancel one or more events associated with the application responsive to determining to deny the request to perform the first type of action.

16. The system of claim 12, wherein the processing device further to:
determine that the first type of action is to delete one or more nodes of the plurality of nodes from the canvas; and
delete the one or more nodes from a graph data structure associated with the canvas responsive to determining to grant the request to perform the first type of action.

17. The system of claim 16, wherein the processing device further to:
send, via the first hook of the plurality of hooks, a message to the bespoke logic to cause the bespoke logic to delete a ruleset associated with the one or more nodes of the plurality of nodes.

18. The system of claim 12, wherein the processing device further to:
determine that the first type of action is to add a connection between a first node of the plurality of nodes and a second node of the plurality of nodes;
add the connection to a graph data structure associated with the canvas responsive to determining to grant the request to perform the first type of action.

19. The system of claim 18, wherein the processing device further to:
send, via the first hook of the plurality of hooks responsive to adding the connection to the graph data structure, a message to the bespoke logic to cause the bespoke logic to connect a first ruleset associated with the first node to a second ruleset associated with the second node.

20. A non-transitory computer-readable medium storing instructions that, when execute by a processing device, cause the processing device to:
execute an application to cause the application to present a canvas and a plurality of nodes together on a display;
configure a plurality of hooks to control communication associated with bespoke logic;
detect a request to perform a first type of action associated with at least the canvas or a node of the plurality of nodes;
acquire, by a processing device, information from the bespoke logic via a first hook of the plurality of hooks that is associated with the first type of action;
determine whether to grant or deny the request to perform the first type of action based on the information; and
grant the request to perform the first type of action responsive to determining to grant the request to perform the first type of action, or
deny the request to perform the first type of action responsive to determining to deny the request to perform the first type of action.
